(19) United States
(12) Patent Application Publication
(10) Pub. No.: US 2020/0184455 A1
(43) Pub. Date: Jun. 11, 2020

(54) Managing Payment Sessions in a Connected Environment

(71) Applicant: Visa International Service Association, San Francisco, CA (US)

(72) Inventor: Venkata Naga Kailash Anantha, Bangalore (IN)

(21) Appl. No.: 16/216,030

(22) Filed: Dec. 11, 2018

(51) Int. Cl. G06Q 20/32; G06Q 20/40; G06Q 20/36

(52) U.S. Cl. CPC G06Q 20/3223; G06Q 20/40145; G06Q 2240/00; G06Q 20/3672; G06Q 20/3674

(57) ABSTRACT

The various embodiments of the present disclosure relate to a system and method for managing payment sessions for enabling connected headgears to make a payment in a connected environment. The connected headgear transacts with one or more merchants with a payment token provisioned on the connected headgear. The payment token is enabled to make payments during an active payment session. The payment session is initiated when the connected headgear is successfully authenticated by a registered rider. During the payment session, the connected headgear transacts with multiple merchants without requiring the rider to authenticate each transaction, and thus carry out transactions without interrupting the rider's journey.

### TECHNICAL FIELD

The embodiments herein are generally related to electronic payments. The embodiments herein are particularly related to managing payment sessions in electronic payments. The embodiments herein are more particularly related to managing payment sessions for the payments initiated by smart wearable devices.

### BACKGROUND

Wearable devices are a fast emerging category of devices in the connected systems and/or Internet of Things (IoT) field that are useful in various day-to-day activities. Multiple wearable devices, such as fitness trackers, healthcare monitors, and navigation devices, have made day-to-day activities convenient.

Connected headgears, such as motorcycle helmets or bicycle helmets with IoT connectivity, are an emerging category of wearable devices that has the potential to enhance the utility of headgears. Among other utilities of the connected headgears, utilizing automatic payment options at places, such as a tollbooth, parking lot, drive-through restaurant, or other similar locations, can enhance ride experience for bike riders.

Moreover, performing authentication of a bike rider while they are operating a motorcycle or bicycle can be dangerous and unsafe in some circumstances. For example, performing an iris scan of a bike rider using an iris sensor while the bike rider is operating a vehicle can interfere with the bike rider's vision in some circumstances.

Hence, there is a need for a system and method for enabling connected headgears to make payments. Further, there is a need for a system and method for managing payment sessions while making payments through connected headgears. Further, there is a need for performing authentication of a connected headgear that does not interfere with the bike rider or create a safety hazard.

The above-mentioned shortcomings, disadvantages, and problems are addressed herein and which will be understood by reading and studying the following specification. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The example embodiment(s) of the present disclosure are illustrated by way of example, and not in way by limitation, in the figures of the accompanying drawings and in which like reference numerals refer to similar elements and in which:

FIG. 1 is a block diagram illustrating a payment processing system during a ride session, in accordance with one or more embodiments.

FIG. 2 is a system diagram of the components of the connected headgear, in accordance with one or more embodiments.

FIG. 3 is a sequence diagram explaining the transaction flow for a purchase made during an active payment session, in accordance with one or more embodiments.

FIG. 4 is a flowchart explaining a method for processing payment during the ride-session, in accordance with one or more embodiments.

FIG. 5 is a use-case diagram of a payment processing during a trip session, in accordance with one or more embodiments.

Although the specific features of the embodiments herein are shown in some drawings and not in others. This is done for convenience only as each feature may be combined with any or all of the other features in accordance with the embodiments herein. While each of the figures illustrates one or more particular embodiment(s) for purposes of illustrating a clear example, other embodiments may omit, add to, reorder, and/or modify any of the elements shown in the figures.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

Prior to discussing embodiments of the disclosure, some terms can be described in further detail.

An “access device” may be any suitable device that provides access to a remote system. An access device may also be used for communicating with a portable device, a network computer, an authorizing entity computer, or any other suitable system. An access device may generally be located in any suitable location, such as at the location of a merchant. An access device may be in any suitable form. Some examples of access devices include point of sale (POS) devices (e.g., POS terminals), cellular phones, personal digital assistants (PDAs), personal computers (PCs), tablet PCs, hand-held specialized readers, set-top boxes, electronic cash registers (ECRs), automated teller machines (ATMs), virtual cash registers (VCRs), kiosks, security systems, access systems, and the like. In some embodiments, an access device can be a device that acts as a payment terminal at a gas station or other location. In some embodiments, where an access device may comprise a POS terminal, any suitable POS terminal may be used and may comprise a reader, a processor, and a computer-readable medium.

An access device may use any suitable contact or contactless mode of operation to send or receive data from, or associated with, a mobile communication or payment device. For example, access devices can have card readers that can include electrical contacts, radio frequency (RF) antennas, optical scanners, bar code readers, or magnetic stripe readers to interact with portable devices such as payment cards.

A “portable device” may comprise any suitable electronic device that may be operated by a user, which may also provide remote communication capabilities to a network. A “portable consumer device” may be an example of a “portable device.” Examples of remote communication capabilities include using a mobile phone (wireless) network, wireless data network (e.g., 3G, 4G, or similar networks), Wi-Fi®, Wi-Max™, or any other communication medium that may provide access to a network such as the Internet or a private network. Examples of portable devices are mobile phones (e.g., cellular phones), PDAs, tablet computers, net books, laptop computers, personal music players, hand-held specialized readers, etc. Further examples of portable devices are wearable devices, such as smart watches, fitness bands, ankle bracelets, rings, earrings, etc., as well as automobiles with remote communication capabilities. In some embodiments, a portable device can function as a payment device (e.g., a portable device can store and be able to transmit payment credentials for a transaction). In an embodiment, a connected headgear may be an example of a portable device.

“Transaction data” may refer to information associated with a transaction. For example, transaction data may comprise one or more of an authorized amount (e.g., transaction amount, item value, etc.), other amount, terminal country code, terminal verification results, transaction currency code, transaction date, transaction type (e.g., card-present transaction, card-not-present transaction, high value transaction, low value transaction, local transaction, international transaction, etc.), an unpredictable number, application interchange profile (AIP), application transaction counter (ATC), issuer application data (IAD), etc.

A “user” may include an individual. In some embodiments, a user may be associated with one or more personal accounts and/or portable devices. The user may also be referred to as a cardholder, account holder, consumer, or bike rider in some embodiments.

“Credentials” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

An “authorization request message” may be an electronic message that requests authorization for an interaction. In some embodiments, it is sent to a transaction-processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV, a dCVV, a PAN, a payment token, a user name, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction-processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

A “network computer” may refer to a computer or a network of computers that processes transactions. In some embodiments, the network computer can be in an electronic system used to accept, transmit, or process transactions made by user devices for money, goods, services, or access to locations or data. The network computer may transfer information and funds among issuers, acquirers, transacting parties, and users. An example of the network computer may include a payment processing server computer such as VisaNet®, operated by Visa®. Payment processing server computers such as VisaNet® are able to process credit card transactions, debit card transactions, and other types of commercial transactions. VisaNet®, in particular includes a Visa Integrated Payments (VIP) system which processes authorization requests and a Base II system which performs clearing and settlement services. In other embodiments, a network computer can be a collection of computers that can allow access to a person seeking to access a particular location. In yet other embodiments, a network computer can be a collection of computers that can allow access to specific types of data (e.g., governmental agencies).

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “payment token” is an alternate identifier that can be used in place of an actual credential such as PAN. The payment tokens can initiate a payment transaction and can be processed by all participants in the payments ecosystem. Payment tokens map back to the underlying account, providing the account issuer with the full transaction details. The payment token can be configured to restrict the usage by device, merchant, transaction type, and channel. A payment token is generally provisioned on the portable device through a tokenization process. Tokenization is the process of replacing the original payment credentials (PAN) with a unique “alternate identifier” which may be used in its stead to initiate payment activity. The tokenization may be offered by a token service provider. One such example of the token service provider is Visa Tokenization Services provided by Visa Inc.

The systems and methods described herein relate to managing payment sessions in a connected environment for enabling a connected headgear to make a payment. The method and system enables the connected headgear to make the payment at various places, such as an automatic tollbooth or an automatic parking lot, without interrupting a bike rider's journey. A payment token is stored on the connected headgear that enables a transaction to take place without requiring the bike rider to stop to make payments at such places. The payment token stored on the connected headgear is enabled during a trip session, which enables the connected headgear to interact with the access devices of the merchants for carrying out the transaction. In one or more embodiments, a “trip session” is a time interval associated with the rider using the connected headgear 102 and may represent, for example, travel by the rider from a first destination to second destination, passage of the rider through a tollbooth, or time interval between the entrance and exit of a rider at a parking lot.

During a trip session, a payment token stored on the connected headgear is enabled which allows merchants to pull payment credentials (payment token) from the connected headgear without interrupting the rider's journey. The rider details, vehicle details, and rider's biometrics are registered in the connected headgear through a registration. The registration is done directly on the application provided on the connected headgear or by a portable consumer device paired with the connected headgear. Further, the payment token is provisioned on the connected headgear. The payment token is provisioned when the connected headgear transmits a tokenization request to a payment platform. The payment platform receives the tokenization request for a PAN belonging to the rider, contacts issuer of the PAN and when the tokenization request is approved, a payment token is generated and then the generated payment token is provisioned on the connected headgear. The provisioned payment token may be conditional based on one or more conditions set by the issuer of the rider. It is possible to provision one or more tokens mapping on the connected headgear relating to one or more PANs. The tokens provisioned on the connected headgear may belong to a single rider having multiple payment credentials or multiple riders.

Further, the connected headgear recognizes one or more actions made by the rider for starting and ending the trip session. When the action for starting the ride is recognized, the one or more payment tokens provisioned on the connected headgear are activated. Upon activation of the payment tokens, the rider is prompted for authentication. For enabling the activated payment tokens to make payments, the rider has to be biometrically authenticated. The authentication is carried out on the connected headgear the rider is wearing. Once the rider is successfully authenticated, a payment session is initiated and the payment token is enabled for the payment during the trip session. In one or more embodiments of the present disclosure, starting of the payment session refers to enabling the activated payment token to make transactions with one or more merchants. It is to be noted that the payment tokens can make transactions with the merchants only during an active trip session.

During the payment session, the connected headgear makes payment to one or more merchants without interrupting the rider's journey. Now, when the rider's action of ending the trip session is detected, the connected headgear ends the payment session by disabling the activated payment token and ends the trip session.

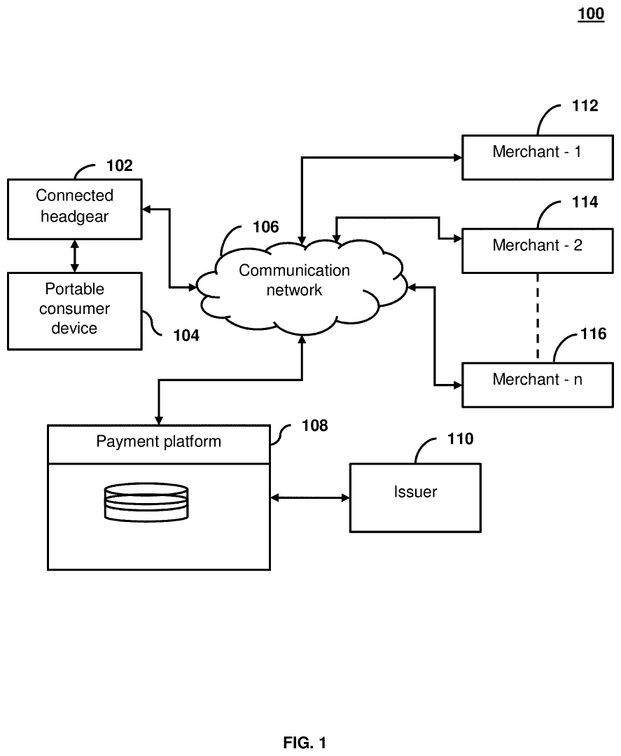

The various embodiments of the present disclosure relate to a system and method for managing a payment session for enabling a connected headgear to make payments. FIG. 1 is a system diagram illustrating an environment in which the connected headgear makes a transaction, in accordance with one or more embodiments. The payment processing system 100 comprises a connected headgear 102, a portable consumer device 104, a communication network 106, a payment platform 108, an issuer bank 110, and one or more merchants 112, 114 and/or 116.

In one or more embodiments, the connected headgear 102 is a head-mounted device that may be worn by the rider while taking a bike journey. The examples of the head-mounted device include a motorcycle or a bike helmet, an augmented-reality (AR) head-mounted device, and a virtual-reality (VR) head-mounted device. The connected headgear 102 according to the present disclosure has a computing and communicating capability that is either in-built or retrofitted to the connected headgear 102. In or more embodiments, the connected headgear 102 has further capabilities relating to sensing, motion, direction, depth, distance, proximity, biometrics, navigation, storage, analytics, multimedia, and the like. The sensing capability of the connected headgear 102 is enabled using a combination of sensors either in-built or retrofitted to the connected headgear 102. The examples of the sensors in the connected headgear 102 are gyroscope, barometer, magnetometer, accelerometer, temperature sensor, pedometer, heart rate monitor, biometric sensor, pressure sensor, glance gesture sensor, tilt-detection sensor, orientation sensor, and global position system (GPS).

The connected headgear 102 may be communicatively coupled to a portable consumer device 104. The process of communicatively coupling the portable consumer device 104 with the connected headgear 102 may be known as pairing. As discussed in the definition section above, the “portable device” may comprise any suitable electronic device that may be operated by a user, which may also provide remote communication capabilities to a network. A “portable consumer device” may be an example of a “portable device.” Examples of remote communication capabilities include using a mobile phone (wireless) network, wireless data network (e.g., 3G, 4G or similar networks), Wi-Fi®, Wi-Max™, or any other communication medium that may provide access to a network such as the Internet or a private network. Examples of portable devices are mobile phones (e.g., cellular phones), PDAs, tablet computers, net books, laptop computers, personal music players, hand-held specialized readers, etc. In some embodiments, a portable device can function as a payment device (e.g., a portable device can store and be able to transmit payment credentials for a transaction).

The block diagram further comprises a communication network 106 that facilitates the communication between devices. The communication network can be both wired and wireless communication networks and the example of such networks include telecommunication network, radio-communication network, the Internet, intranet, extranet, Wire Area Network (WAN), Local Area Network (LAN), Home Area Network (HAN), Dedicated Short Range Communication (DSRC), Global System for Mobile Communication (GSM), Bluetooth®, General Packet Radio Services (GPRS), Wi-Fi®, ZigBee®, Near-Field Communication (NFC), and the like.

Furthermore, the block diagram comprises a payment platform 108 that facilitates a payment transaction between multiple parties involved in the payment ecosystem. The payment platform 108 comprises a network computer, a payment gateway, and a payment tokenization service.

In one or more embodiments, the block diagram comprises an issuer 110. Again, as described above, an “issuer” may refer to a business entity (e.g., a bank) that issues and optionally maintains an account for a user. An issuer may also issue payment credentials stored on a user device, such as a cellular telephone, smart card, tablet, or laptop, to the consumer, connected headgear, or in some embodiments, a portable device.

The merchants (112, 114 and 116) are the entities that engage in transactions and can sell goods or services, or provide access to goods or services.

In one or more embodiments, the connected headgear 102 interacts with merchant(s) through the communication network 106 completing a payment transaction. The payment platform 108 facilitates the payment transaction between the connected headgear 102 and the merchant 112/114/116.

Initially, to start a transaction, the connected headgear should have an active trip session. The trip session is activated when the rider starts the ride by performing one or more predefined initiation actions that activate the connected headgear 102. In one or more embodiments, an “initiation action” is a movement or gesture of the rider that may be detected by connected headgear 102. Examples of an initiation action include, for example, equipping the connected headgear 102 on the rider's head, securing a chinstrap of the connected headgear 102, lifting or closing a visor of the connected headgear 102, tapping the connected headgear 102 in a specific location, such as near the ear or on the top of the head, pressing a button on the exterior surface of the connected headgear 102, or any other similar type of motion or gesture that may be detected by the connected headgear 102. The connected headgear 102 is programmed or configured to detect the initiation action and initiate the trip session based on that detection.

In one or more embodiments, once the initiation action is detected, one or more payment tokens provisioned on the connected headgear 102 are activated. The activation of the payment token on the connected headgear 102 may refer to making the connected headgear 102 operative for the payment transaction. In one or more embodiments, connected headgear 102 may be provisioned with one or more payment tokens during a registration process, as will be discussed herein.

Once the payment tokens are activated, the connected headgear 102 is programmed or configured to authenticate the rider. The rider is biometrically authenticated by one or more biometric sensors present in the connected headgear 102. In an embodiment, the biometric sensors are present as retractable iris sensors that authenticate the rider's iris. In one or more embodiments of the present disclosure, the retractable iris sensors are part of the connected headgear 102 and are embedded on the visor or retrofitted to the connected headgear 102. The retractable iris sensors capture the iris of the user without intruding the rider's vision or causing trouble for riding the vehicle. The retractable sensors in the connected headgear 102 may authenticate the rider only once per session. Further, retractable iris sensors may further authenticate the rider using pattern analysis, glance analysis, and the like. It is also possible that the connected headgear 102 authenticates the rider by using the iris authentication mechanism available on the paired portable consumer device 104.

In other embodiments, the biometric sensors may be pulse rate sensors, glance sensors, face recognition module, voice recognition module, and the like that would identify the rider for that trip session. The biometric verification is based on matching locally stored biometrics on the connected headgear 102 with the biometrics provided at the premise. However, in other embodiments, the biometrics are stored and matched remotely. It is possible that when the rider is successfully authenticated, all the payment tokens corresponding to that rider's profile are activated for making payment. In an embodiment, the rider may select the payment token to be used for the trip session. The rider may choose the payment token to use for the trip on the fly or provide preferences during the registration during the token provisioning process. The process of token provisioning on the connected headgear 102 is explained in detail later in the description.

Once the connected headgear 102 successfully authenticates the rider, a payment session is started for the activated payment token. In one or more embodiments of the present disclosure, starting of the payment session refers to enabling the activated payment token to make transactions with one or more merchants. It is to be noted that the payment tokens can make transactions with the merchants only during an active trip session. Further, only the activated payment tokens can make payments with the merchants during the trip session. Using that activated payment token, the rider may initiate a payment transaction with one or more merchants during that trip session. The trip session ends when an ending action is detected by connected headgear 102. An “ending action” is a movement or gesture of the rider that may be detected by connected headgear 102. Examples of an ending action include, for example, removing the connected headgear 102 from the rider's head, unlocking a chinstrap of the connected headgear 102, lifting or closing a visor of the connected headgear 102, tapping the connected headgear 102 in a specific location, such as near the ear or on the top of the head, pressing a button on the exterior surface of the connected headgear 102, or any other similar type of motion or gesture that may be detected by the connected headgear 102. Further, when the trip session ends, the payment session is also ended and the payment token is deactivated, and in this state the connected headgear 102 cannot initiate a payment transaction.

In accordance with one or more embodiments, the rider may make a registration to an application that enables the connected headgear 102 to make payments. The registration is done by associating the rider details, vehicle details, one or more biometrics of the rider, and/or one or payment credentials of the rider with the application. In an embodiment, “rider details” comprise data that may be used to identify the rider, and may comprise information such as the rider's name, address, social security number, date of birth, driver's license number, or any other similar identifying information. In an embodiment, “vehicle details” comprise data that may be used to identify the vehicle, and may comprise information such as the model of the vehicle, make of the vehicle, and/or the vehicle identification number (VIN). In an embodiment, “payment credentials” may comprise any identifying information that may be used to initiate a payment transaction. For example, in an embodiment, payment credentials of the rider comprise the bank details and/or the PAN through which the connected headgear 102 makes the payment. The initial registration is done by associating details directly on the user interface of an application available on the connected headgear 102 or via the portable consumer device 104. As explained in the above definitions, the portable consumer device 104 is a device having network connectivity and is capable of communicating with other devices. The examples of the portable consumer device 104 include, but are not limited to, a smartphone, a laptop, a tablet computer, a palmtop, or any other microprocessor enabled device. The rider may use short-range communication protocols such as Bluetooth®, NFC, infrared, and the like for initial communication between the connected headgear 102 and the portable consumer device 104. The rider may also use a wired connection from the portable consumer device 104 to the connected headgear 102 for pairing and inputting details for the registration.

Further, after the registration, the connected headgear 102 transmits a tokenization request from each of the PANs associated during the registration, to the payment platform 108 for provisioning a payment token on the connected headgear 102.

The connected headgear 102 transmits the details to the payment platform 108 using the communication network 106. The examples of the communication network 106 include both wired and wireless communication networks. The examples of the communication network 106 include the Internet, intranet, radio communication network, telecommunication network, long-range communication network, and/or short-range communication network. In an embodiment, the payment platform 108 may include a payment gateway, a payment network, and/or one or more services provided by the payment gateway and/or the payment network. The payment platform 108 further comprises tokenization services provided either by the payment network itself or by a third-party tokenization provider. Tokenization refers to providing an alias for the payment credentials and thereby preventing exposure of the actual PAN credentials. Tokenization is a process of substituting the actual payment credentials (PAN) with unique, randomly generated characters. Tokenization provides improved fraud protection and minimizes identity theft and risk.

Payment platform 108 is programmed or configured to send a message to the issuer 110 of the PAN to provision a token on the connected headgear 102. Issuer 110 is a financial institution such as a bank who approves or rejects transaction made by the rider. According to one or more embodiments of the present disclosure, the issuer 110 is an authorizing entity that authorizes a request. The issuer 110 may refer to a business entity (e.g., a bank) that issues and optionally maintains an account for a user.

Once the issuer 110 approves the tokenization request, a token is created by the payment platform 108 for the payment credentials of the rider and is stored in the connected headgear 102. The token created and provisioned on the connected headgear 102 may be conditional and has one or more conditions such as specific merchant usage, limited period usage, and the like. The actual mapping of the PAN and the token is stored in a token vault provided by the payment platform 108.

Once the payment token is activated during the payment session, the rider has the ability to transact using the activated payment token without needing continuous authentication. When the rider makes a purchase, the purchase details are optionally shared with the rider through the user interface of the connected headgear 102 or the portable consumer device 104 paired with the connected headgear 102. In an embodiment, the rider approves the transaction using one or more methods such as voice approval, gesture approval, action approval, and the like. Once the approval is received, the activated payment token is shared from the connected headgear 102 to the merchant and/or the merchant acquirer who further sends the payment token and transaction details to the payment platform 108 as part of a payment authorization request. In an alternate embodiment, the approval from the rider is not necessary and the merchant pulls the activated payment token from the connected headgear 102 and proceeds for payment processing. The payment platform 108 verifies the payment token and the transaction details, then detokenizes the received payment token to extract the actual payment credential (PAN) of the rider and then forwards transaction data and original PAN to the issuer 110 for authorization. According to one or more embodiments of the present disclosure, detokenization is a process of retrieving the original data from the payment token based on the token-to-PAN mapping stored in the token vault.

The issuer 110 approves or rejects the transaction and then sends authorization response back to the payment platform 108. The payment platform 108 again retokenizes the payment credentials of the rider and sends the authorization response and the transaction details to the merchant or the merchant acquirer. In one or more embodiments of the present disclosure, the term retokenize may refer to again encrypt the payment token to remove or alter the identifiable payment credentials of the user. The merchant or the merchant acquirer later settles the transaction using one or more settlement processes known in the art. The merchant sends the updated payment status to the connected headgear 102.

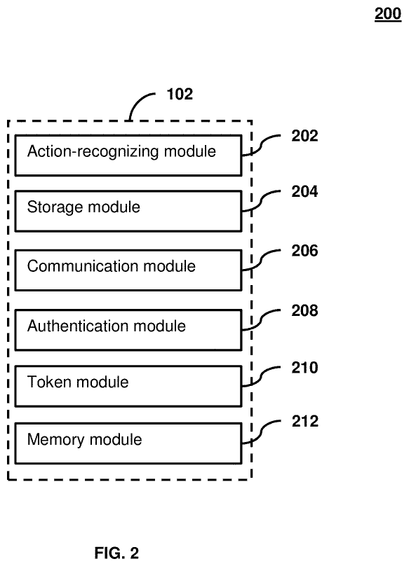

FIG. 2 is a system diagram 200 of the components of connected headgear 102 in accordance one or more embodiments. The components of the connected headgear 102 may comprise, but are not limited to, an action-recognizing module 202, a storage module 204, a communication module 206, an authentication module 208, a token module 210, and/or a memory module 212. The connected headgear 102 may include many more modules such as a display module, user interface module, geo-location module and the like, which are not shown in FIG. 2. In one or more embodiments, the action-recognizing module 202 is programmed or configured to detect one or more initiation actions and/or one or more ending actions performed by the rider of the connected headgear 102. In an embodiment, the detection of the actions is based on the preconfigured actions programmed into the connected headgear 102 and/or the actions defined and customized by the rider. Upon detecting the action, the action-recognizing module 202 is programmed or configured to activate or deactivate the trip session. For example, when the action of wearing the connected headgear 102 is recognized, the trip session is initiated and when the action of removing the connected headgear 102 is recognized, the trip session is ended.

Storage module 204 is programmed or configured to store data including details of the rider, vehicle, and/or the connected headgear 102. The details, such as rider name, rider profile, vehicle name, vehicle profile, payment credentials of the rider, biometrics of the rider, and the like, are stored by the storage module 204. The storage module 204 is accessible locally and/or remotely based on the configuration set by the rider or the manufacturer. The storage module 204 is initially updated based on the data associated by the rider during registration. The data is updated using the user interface provided on the connected headgear 102 or through the paired portable consumer device 104.

Communication module 206 is programmed or configured to provide a communication interface for communicating with the internal and external components of the connected headgear 102. The communication module 206 uses one or more communication protocols that uses a variety of communication networks such as Internet, intranet, wired and wireless protocols, telecommunication network, NFC, radio network, and the like.

Token module 210 is programmed or configured to store one or more payment tokens for enabling connected headgear 102 to make payments during the trip session. In one or more embodiments, the token module 210 interfaces with the payment platform (not shown in FIG. 2) to tokenize the payment credentials (PAN) provided by the rider at the time of registration. The token module 210 is programmed or configured to retrieve the details from the storage module 204 and send a tokenization request to payment platform 108. Payment platform 108, after receiving tokenization approval from the rider's issuer, is programmed or configured to generate a payment token and provision the payment token on the token module 210. The payment token is provisioned using one or more methods known in the art such as token provisioning using secure element, Host Card Emulation (HCE), and the like.

The payment tokens are passed through the communication network 106 to process payment without exposing actual payment credentials. The actual payment credentials of the rider are held safe in a secure token vault provided by the payment platform. Further, the token module 210 is programmed or configured to monitor the trip session and manage the payment session. In an embodiment, when the trip session is started payment tokens stored in the connected headgear 102 are enabled to make payments to the merchants.

In one or more embodiments of the present disclosure, the rider through the connected headgear 102 makes purchases and transacts with one or more merchants. The purchases may be made hands-free when the rider is riding the bike wearing the connected headgear 102. When the purchase is made, the merchant shares the transaction details to the rider's connected headgear 102 or to the portable consumer device 104 paired with the connected headgear 102. Once the transaction details are received from the merchant during the active payment session, the token module 210 shares the activated payment token with the merchant and/or the merchant acquirer. In an embodiment, the payment token is then transmitted to the payment platform 108 and after successful authorization, the authorization response is stored in the storage module 204 of the connected headgear 102. In an embodiment, the token module 210 shares the payment token only when the trip session and the payment session are active and the rider is successfully authenticated. If either the trip session or the payment token is not activated, the transaction is declined. In such cases, a fallback mechanism may be implemented where the transaction is processed without the help of the connected headgear 102.

The token module 210 is programmed or configured to deactivate the payment token and end the payment session when the trip session ends. The indication of the trip session ending is detected by the action-recognizing module 202. Further, the token module 210 is configured to end the active payment session if there are one or more predefined errors or unrecognized errors or whenever the security threshold for using the payment token is not fulfilled.

Authentication module 208 is programmed or configured to authenticate the rider. In accordance with one or more embodiments of the present disclosure, when the action for activating the connected headgear 102 is recognized, the authentication module 208 proceeds to authenticate the rider by launching the authentication challenge. In one or more embodiments of the present disclosure, the authentication challenge can be described as a challenge or a process that the authentication module 208 presents to the rider to confirm his/her identity by providing a valid response. The authentication module 208 is programmed or configured to use one or more sensors made available on the connected headgear 102 for authenticating the rider. For example, the rider is prompted to provide a biometric such as iris scan for authentication. The authentication module 208 fetches the biometrics stored in the storage module 204 and matches the biometrics provided on premise and authenticates the rider. If the authentication is successful, a payment session is activated and if the authentication is not successful, the payment session is not activated. In one or more embodiments of the present disclosure, the authentication challenge may be prompted on the portable consumer device 104 paired with the connected headgear 102. In situations where the authentication challenge had to be prompted on the portable consumer device 104, the authentication module 208 interfaces with one or more modules responsible in the portable consumer device 104 to authenticate the rider.

The connected headgear 102 optionally comprises a session monitoring module (not shown in the FIG. 2) for monitoring the trip session and payment session. The session monitoring module is programmed or configured to monitor and analyze both the trip session and payment session. The analysis done by the session monitoring module is shared with the payment platform and other business intelligence providers for improving the ride efficiency and payment session efficiency. The session monitoring module allows the payment token to be shared with the merchant only when the payment session is initiated. In the absence of the session monitoring module, these functionalities are distributed between the storage module 204 and the token module 210.

The connected headgear 102 comprises a memory module 212 programmed or configured to store information required for working of the connected headgear 102. The memory module 212 comprise primary memory, secondary memory, and other forms of memory that are required for operating the connected headgear 102.

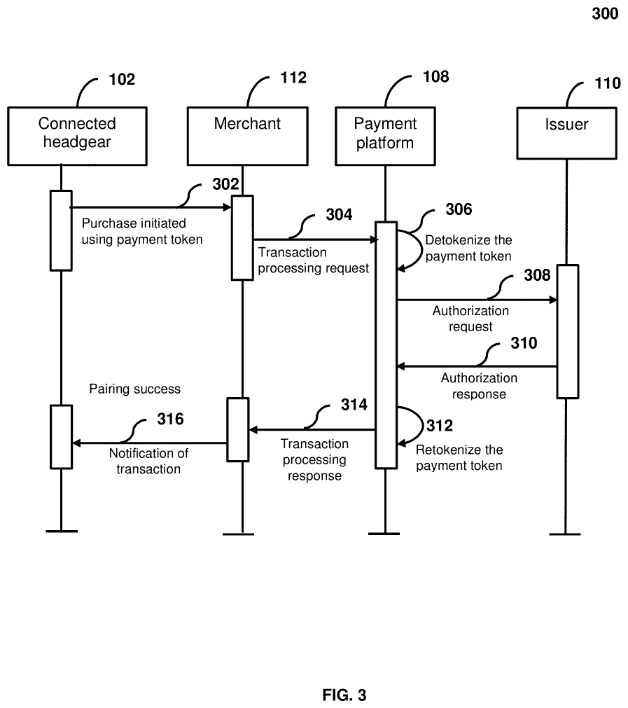

FIG. 3 is a sequence diagram explaining the transaction flow for a purchase made during an active payment session according to one or more embodiments of the present disclosure. The transaction flow 300 starts when the purchase is initiated by the connected headgear 102 by sharing the payment token to the merchant 112 (Step 302). The payment token may be shared with the merchant 112 using either pull payments or push payments known in the art. The merchant 112 along with the transaction details shares the payment token and the transaction details to the payment platform 108 (Step 304). The payment platform 108 detokenizes the payment token and does additional verification of the tokens if required (Step 306). Then, the payment platform 108 shares the transaction details and the payment credentials with the issuer 110 for payment authorization (Step 308). The issuer 110 makes the authorization decision and sends the authorization response to the payment platform 108 (Step 310). The payment platform 108 again retokenizes the payment credentials to payment token (Step 312). The authorization response and the transaction details are again sent back to the merchant 112 (Step 314). The merchant 112 shares the receipt and the transaction response to the connected headgear 102 directly or through the paired portable consumer device (Step 316).

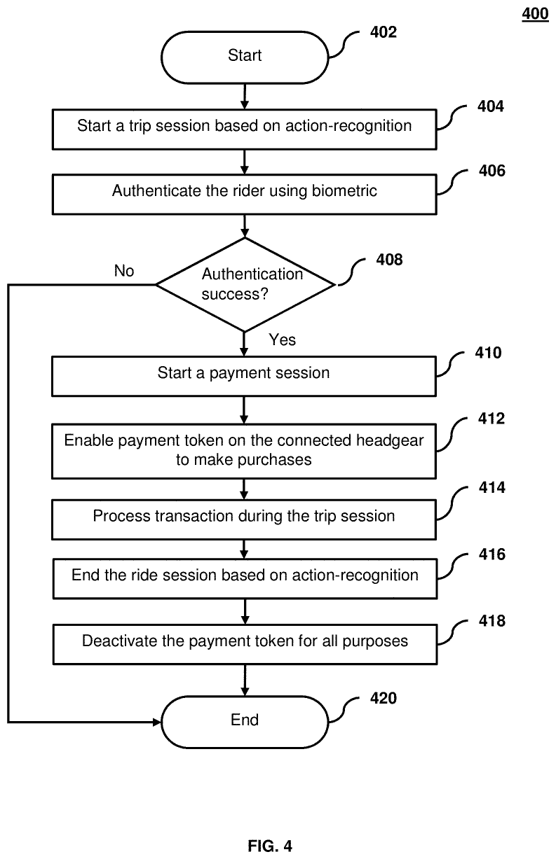

FIG. 4 is a flowchart explaining a process 400 for managing a payment session in a connected headgear 102 during a trip session in accordance with one or more embodiments. Process 400 may commence at step 402. A trip session is initiated based on connected headgear 102 detecting an initiation action (Step 404). As described earlier, the initiation action can comprise wearing the connected headgear. Once the initiation action for starting the trip session is detected, process 400 activates payment tokens provisioned on the connected headgear and proceeds for authenticating the rider biometrically (Step 406). The authentication is based on one or more authentication challenges posed by the connected headgear at the start time of the trip session (Step 408). In accordance with one or more embodiments of the present disclosure, the authentication challenges are authentication challenges posed by the connected headgear 102 to identify the rider of the bike. The examples of the authentication challenges posed by the connected headgear 102 may comprise iris recognition, face recognition, voice recognition, pulse recognition, body profile recognition, behavior recognition, and the like. The authentication challenges are posed either independently or as a combination of one challenge. The rider provides the biometrics and connected headgear 102 verifies the biometric either locally or on a remote device. If the rider is successfully authenticated, a payment session is started (Step 410), and if the rider is not authenticated successfully, the payment session is either ended or aborted (Step 420). Further, after the starting of the payment session, the activated payment token is enabled for making payments (Step 412). In case, the rider has one or more payment credentials attributed in the connected headgear, the rider chooses the payment token that has to be enabled for that particular payment session. On the other hand, the preferences provided by the rider during the registration is fetched and the corresponding payment token is enabled for making payments at this payment session. According to an embodiment herein, the rider makes payments to one or more merchants during the trip session using the payment token enabled on the connected headgear in the payment session.

Further, once the rider makes the transaction, the payment is processed by the payment platform 108 (Step 414). The most common examples of the purchase initiated by the connected headgear 102 are tollbooth tickets and a parking space ticket. In continuation with said example, when the trip session is active and payment token is enabled for making payments, the automatic tollbooth 506 sends a payment request to the connected headgear 102 either directly or through the paired portable consumer device 104. The connected headgear 102 optionally seeks the approval of the rider before making the payment to the merchant 112/114/116. The approval is obtained from the rider using one of the approval methods known in art such as voice approval, gesture approval, or a signifier placed on the bike to approve payment. Once the payment is approved, the payment token is passed to the merchant from the connected headgear 102 through the payment platform 108 either using pull payment method or push payment method known in the art. The payment platform 108 then verifies the status of the payment token, detokenizes the payment token, and transmits the original payment credentials and the transaction details to the issuer of the rider for authorization. The issuer of the connected headgear approves the transaction if a plurality of rules is satisfied and pulls the funds from the rider's account. The updated transaction details along with an invoice/digital receipt is shared with the connected headgear 102 or with the portable consumer device 104 paired with the connected headgear 102. It is to be noted that the payment process is enabled only when the payment session is activated, which in turn means the trip session has to be started and the rider has to be successfully authenticated.

Further, when the action for removing the connected headgear 102 is detected, the trip session is ended (Step 416) which subsequently ends the payment session, deactivating the payment token session for all purposes (Step 418). When the payment token session ends, the rider can no longer make payments using the connected headgear.

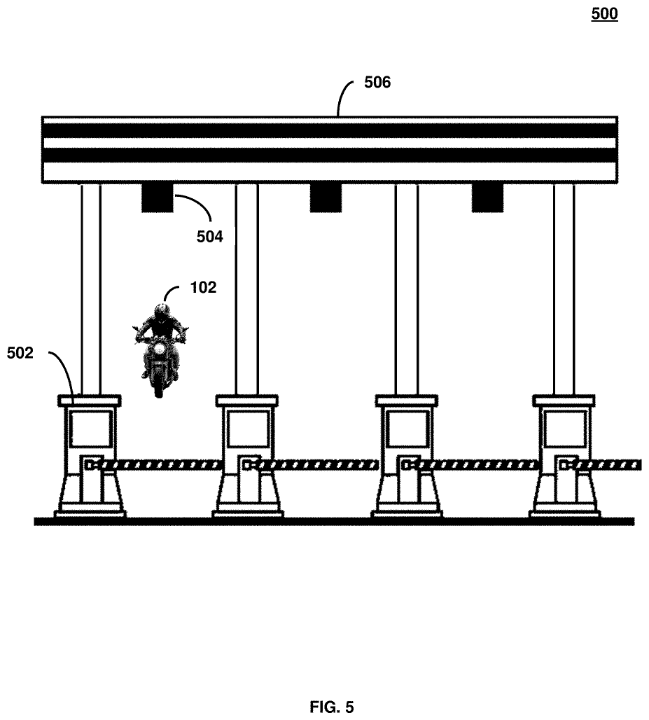

FIG. 5 is a use-case diagram of a payment processing during a trip session 500 in accordance with the present disclosure. The figure depicts the use of the connected headgear 102 in an automatic tollbooth scenario. In one or more embodiments, the automatic tollbooth comprises a monitoring system 506 and a digital ticketing counter 502. The rider initially starts a trip session and successfully authenticates himself, which will activate the payment tokens and initiate a payment session. This enables the connected headgear 102 to transact with merchants. Transacting with the merchants using the connected headgear 102 will allow the rider to make hands-free payment while riding the bike. In the current scenario, where the rider is passing through a roadway which the automatic toll is enabled, the monitoring system 506 recognizes the bike using one of the methods available for recognizing vehicles at tollbooths. The examples of the methods used for recognizing the bike comprises number plate recognition, RFID tag recognition, smart-tag recognition, and the like. Further to the recognition of the bike, the monitoring system 506 transmits the bike details to the digital ticketing counter 502, which then issues a digital ticket for the bike and requests for payment. The monitoring system 506 recognizes the bike with the help of the tracking device 504 that tracks and recognizes the bike. The digital ticket and the payment request is received by the connected headgear 102 and with the approval of the rider, shares the payment details with the ticketing counter 502. The digital ticketing counter 502, which is a merchant in this scenario, further transmits the payment details to the payment platform 108 for processing. After successful authorization, the digital ticketing counter 502 updates the payment status to the connected headgear 102 or to the portable consumer device 104 paired with the connected headgear 102. The monitoring system 506 monitors the distance travelled by the rider using the methods known in the state-of-the-art and then transmits the bike details and the distance travelled by the bike to the digital ticketing counter 502, which raises a digital ticket and transmits the digital ticket and the payment request to the connected headgear 102. In case the transaction from the connected headgear 102 could not be processed by the monitoring system 506 due to various reasons, a fallback mechanism is employed such as photographing the bike, offline ticketing system, and the like.

In one or more embodiments of the present disclosure, the architecture of the automatic tollbooth for requesting and processing payment may be a single-node architecture or a multi-node architecture. In the single-node architecture, the monitoring system 506 is a centralized node that handles all the processes such as connection requests, communication with the connected headgear 102, transaction processing, and the like. In a multi-node architecture, there are multiple nodes, namely, a central node and two relay nodes (e.g., Gatekeeper nodes). Each of the relay nodes performs recognition of the bike, communication with the connected headgear, time duration of the connected headgear in the roadway, and the like. The central node focuses on the transaction processing.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A computer-implemented method for managing a payment session for a connected headgear, the method comprising:
initiating a trip session by recognizing an initiating action performed by a rider of the connected headgear;
activating one or more payment tokens provisioned on the connected headgear;
authenticating the rider by verifying one or more biometrics of the rider, wherein the biometrics were previously stored on the connected headgear during a registration, thereby creating an authenticated rider;
based on authenticating the rider, initiating a payment session for the one or more payment tokens to enable the connected headgear to make payments with merchants, wherein the one or more payment tokens correspond to the authenticated rider;
processing a payment transaction for the one or more payment tokens during the payment session;
ending the trip session by recognizing an ending action performed by the rider of the connected headgear; and
ending the payment session by deactivating the one or more payment tokens to disable the connected headgear from processing payment transactions.

2. The method according to claim 1, wherein the trip session refers to a time interval associated with the rider using the connected headgear and represents travel time by the rider from a first destination to a second destination.

3. The method according to claim 1, wherein the initiating action performed by the rider for initiating the trip session and ending the trip session is selected from one or more preconfigured actions.

4. The method according to claim 1, wherein the one or more payment tokens are stored on a hardware element, a software element, or a combination thereof available on the connected headgear.

5. The method according to claim 1, wherein registration involves attributing one or more details of the rider to the connected headgear, and wherein the one or more details comprise a rider profile, a vehicle profile, and one or more payment credentials of the rider that enables the connected headgear to make transactions.

6. The method according to claim 1, wherein authenticating the rider is by verifying an identity of the rider by prompting an authentication challenge to the rider upon initiating the trip session, and wherein the authentication challenge is prompted on either the connected headgear or on a portable consumer device paired with the connected headgear.

7. The method according to claim 1, wherein processing the payment transaction for the connected headgear made by one or more activated payment tokens during the payment session comprises:
receiving payment details from a merchant, wherein the payment details comprise transaction details, merchant details, and details about the one or more payment tokens, thereby creating a received payment token;
detokenizing the activated payment token to extract a primary account number (PAN) corresponding to the payment token, wherein detokenizing further allows validation of the received payment token, and wherein the detokenization is processed in a token vault;
transacting with an issuer of the PAN for payment authorization, wherein transacting with the issuer comprises transmitting the PAN of the rider, transaction information and other information required by the issuer for a payment authorization decision, and receiving a payment authorization response; and
transmitting the payment authorization response to the merchant along with retokenizing the PAN to the corresponding token, and wherein the retokenization is processed in the token vault.

8. The method according to claim 1, wherein the method managing a payment session for a connected headgear further comprises provisioning the payment token on the connected headgear, wherein the provisioning of the payment token comprises the steps of:
receiving one or more payment credentials of the rider, wherein the payment credentials comprise a payment card number and/or a primary account number (PAN) of a user;
initiating a tokenization request to an issuer for the PAN;
receiving an approval for tokenization of the PAN from the issuer of the rider;
generating a payment token after successful tokenization approval, wherein the payment token is an alias for the PAN, and wherein the payment token is generated by substituting a unique, randomly-generated character sequence in place of the PAN, and wherein the generated payment token has a restriction for usage;
storing the generated payment token and the PAN in a token vault, wherein the token vault stores mapping of the PAN and a corresponding generated token; and
provisioning the generated payment token on a secure element hosted on the connected headgear.

9. The method according to claim 1, wherein a secure element comprises a tamper-proof storage module that is available on the connected headgear as a local element, a remote element, or a combination thereof.

10. The method according to claim 9, wherein a payment platform comprises a payment gateway, a payment network, and a plurality of services provided by the payment gateway and the payment network, and wherein the plurality of services includes tokenization services.

11. The method according to claim 9, wherein an action-recognition module is programmed to recognize an action of activating and deactivating a trip session using one or more sensors embedded on the connected headgear, and wherein the sensors are programmed to detect the action using one or more predefined actions of a user.

12. The method according to claim 9, wherein an authentication module is configured to authenticate the rider by providing an authentication challenge to the rider, and wherein the authentication challenge is a biometric challenge, and wherein the authentication is established by comparing a biometric provided by the rider on the premise with a biometric stored previously.

13. The method according to claim 9, wherein the tamper-proof storage module is configured to store one or more biometrics of a user, and wherein the storage module stores the biometrics either locally on the connected headgear or on a storage system located remotely from the connected headgear.

14. The method according to claim 9, wherein a token module is configured to tokenize one or more payment credentials of the rider by replacing the payment credentials with one or more alternate identities, and wherein tokenized details are stored in a token vault, and wherein the token vault has a limited access by one or more modules available on the connected headgear.

15. The method according to claim 1, wherein restrictions on a generated payment are based on one or more attributes of the rider, a vehicle, and an issuer, and wherein the restrictions may be set by the rider, a manufacturer of the vehicle, and the issuer.

16. The method according to claim 15, wherein an authentication module in the connected headgear is configured to authenticate the rider upon the initiation of the trip session by promoting an authentication challenge on the connected headgear or on a portable consumer device paired with the connected headgear.

17. The method according to claim 15, wherein a payment platform is configured to initially provision a token on the connected headgear for enabling the connected headgear to make transactions, wherein the provisioning the token on the connected headgear comprises:
receiving one or more payment credentials of the rider, wherein the payment credentials comprise payment card number and/or a primary account number (PAN) of the rider, wherein the payment credentials are received through a user interface of a connected device or through a portable consumer paired with the connected headgear;
initiating a tokenization request to an issuer bank for the received PAN;
receiving an approval for tokenization of the PAN from the issuer bank;
generating a payment token after successful tokenization approval, wherein the payment token is an alias for the PAN, and wherein the payment token is generated by substituting a unique, randomly-generated character sequence in place of the PAN, and wherein the generated payment token comprises one or more rules based on a profile of the rider, a profile of a vehicle, and an issuer of the PAN, and wherein the one or more rules are set by the rider, a manufacturer of the vehicle, or the issuer of the PAN;
storing the payment token and the PAN in a token vault, wherein the token vault stores mapping of the PAN and the corresponding generated token; and
provisioning the payment token on a secure element hosted on the connected headgear, wherein the secure element is either a software secure element, a hardware secure element, or a combination thereof.

18. The method according to claim 15, wherein the connected headgear and a payment platform communicate using a communication network, wherein the communication network uses a plurality of communication protocols to communicate with each other.

19. The method according to claim 15, wherein the connected headgear optionally comprises a session monitoring module interfacing with an authentication module and a token module configured for monitoring the trip session and the one or more payment session, wherein the session monitoring module allows the token module to share the payment token only when the trip session is active.

20. A system for managing a payment session to enable a connected headgear to make a payment during a trip session, the system comprising:
a payment platform configured for enabling the connected headgear to make payments during the trip session; and
the connected headgear in communication with the payment platform, wherein the connected headgear comprises a plurality of components, and wherein the plurality of components comprises:
an action-recognition module configured for recognizing one or more actions performed by a rider for activating and deactivating the trip session;
a storage module configured for storing one or more biometric samples of the rider;
an authentication module interfacing with the storage module and configured for authenticating the rider for starting the trip session; and
a token module in communication with the authentication module configured for activating a payment token for enabling the connected headgear to make payments,
wherein the payment platform processes the payment only when the payment token is activated.
